(19) United States
(12) Patent Application Publication
(10) Pub. No.: US 2011/0080447 A1
(43) Pub. Date: Apr. 7, 2011

(54) FLUID EJECTING APPARATUS

(75) Inventor: Tatsuya SESHIMO, Asahi-mura (JP)

(73) Assignee: SEIKO EPSON CORPORATION, Tokyo (JP)

(21) Appl. No.: 12/898,786

(22) Filed: Oct. 6, 2010

(30) Foreign Application Priority Data
Oct. 7, 2009 (JP) 2009-233493

(51) Int. Cl. B41J 2/165

(52) U.S. Cl. 347/31

(57) ABSTRACT

Provided is a fluid ejecting apparatus including: a fluid ejecting head which includes a nozzle row formed of a plurality of nozzles ejecting a fluid; a linear fluid absorbing member which extends along the nozzle row, and is movable between a position of receiving the fluid ejected from the nozzles and a position retreating from a flying path of the fluid; and a vibration suppressing member which damps vibration of the fluid absorbing member.

### CROSS REFERENCES TO RELATED APPLICATIONS

The entire disclosure of Japanese Patent Application No. 2009-233493, filed Oct. 7, 2009, is expressly incorporated by reference herein.

### BACKGROUND

1. Technical Field

The present invention relates to a fluid ejecting apparatus.

2. Related Art

An ink jet printer (hereinafter, referred to as “a printer”) is widely known as a fluid ejecting apparatus which ejects ink droplets onto a printing sheet (medium). In this kind of printer, since ink evaporates from a nozzle of a printing head, ink in the nozzle is thickened or solidified, dust is attached to the nozzle, and bubbles are mixed with the ink in the nozzle, which causes an erroneous printing process. Therefore, generally, in a printer, in addition to an ejection operation of ejecting ink to a printing sheet, a flushing process of compulsorily ejecting ink in the nozzle to the outside is performed.

In a scanning-type printer, the flushing process is performed by moving a printing head to an area other than a printing area. However, in a printer including a line head in which a printing head is fixed, the printing head cannot move during a flushing process. Therefore, for example, JP-A-2005-119284 proposes a method of ejecting ink toward absorbing members provided in a surface of a sheet transporting belt.

However, in the method disclosed in JP-A-2005-119284, since the plural absorbing members are arranged at the same interval on the sheet transporting belt in accordance with the size of the printing sheet, problems arise in that ink needs to be ejected in every gap between the printing sheets during the flushing process, and in that the size or transporting speed of the printing sheet is limited. In addition, when the flushing process is performed on a planar absorbing member, ink is scattered in the form of a mist due to a wind pressure caused by an operation of ejecting ink droplets, which may contaminate the printing sheet or the sheet transporting belt.

Therefore, a method is proposed which easily and promptly performs a flushing process by forming an absorbing member in a linear shape.

However, when the absorbing member is formed in a linear shape, an area for receiving ink in the absorbing member is decreased compared with a planar absorbing member. In addition, the linear absorbing member is easily vibrated compared with the planar absorbing member.

For this reason, when the absorbing member is formed in a linear shape, the absorbing member may deviate from the area receiving the ink due to the vibration of the absorbing member, whereby a printing sheet or a transportation belt may become contaminated.

### SUMMARY

An advantage of some aspects of the invention is that it provides a fluid ejecting apparatus capable of reliably receiving a fluid by a fluid absorbing member during a flushing process even when the fluid absorbing member is formed in a linear shape.

The following configuration is adopted in order to solve the above-described problems. An aspect of the invention provides a fluid ejecting apparatus including: a fluid ejecting head which includes a nozzle row formed of a plurality of nozzles ejecting a fluid; a linear fluid absorbing member which extends along the nozzle row, and is movable between a position of receiving the fluid ejected from the nozzles and a position retreating from a flying path of the fluid; and a vibration suppressing member which damps vibration of the fluid absorbing member.

According to the fluid ejecting apparatus with such a configuration, the vibration of the fluid absorbing member is damped by the vibration suppressing member. Accordingly, it is possible to suppress the fluid absorbing member from deviating from the area receiving the fluid ejected from the nozzle of the fluid ejecting head.

Therefore, according to the fluid ejecting apparatus, even when the fluid absorbing member is formed in a linear shape, it is possible to reliably receive the ink by the use of the fluid absorbing member during the flushing process.

In the fluid ejecting apparatus, the linear fluid absorbing member may be 15 to 50 times larger than the diameter of the nozzle.

According to the fluid ejecting apparatus with such a configuration, the fluid absorbing member can be disposed between the fluid ejecting head and the medium, and the ejected fluid can be captured by the fluid absorbing member even when the component errors are considered.

In the fluid ejecting apparatus, the vibration suppressing member may include a contact portion coming into contact with the fluid absorbing member, and an elastic body connected to the contact portion and damping the vibration by the use of its elastic deformation.

According to the fluid ejecting apparatus with such a configuration, the vibration of the fluid absorbing member is transmitted to the elastic body via the contact portion, whereby the elastic body is elastically deformed. As a result, the restoring force of the elastic body is transmitted to the fluid absorbing member via the contact portion, so that the vibration of the fluid absorbing member can be damped.

Therefore, according to the fluid ejecting apparatus, it is possible to damp the vibration of the fluid absorbing member with a simple and easy configuration.

In the fluid ejecting apparatus, the vibration suppressing member may be a nipping member which movably nips the fluid absorbing member, and damps the vibration by the use of friction resistance generated between the fluid absorbing member and the nipping member.

According to the fluid ejecting apparatus with such a configuration, when the fluid absorbing member is vibrated, the fluid absorbing member slides on the nipping member. As a result, friction resistance is generated between the fluid absorbing member and the nipping member, which damps the vibration of the fluid absorbing member.

Therefore, according to the fluid ejecting apparatus, it is possible to damp the vibration of the fluid absorbing member with a simple and easy configuration.

In the fluid ejecting apparatus, the nipping member may nip the fluid absorbing member in a slit between two pieces formed by dividing the nipping member.

According to the fluid ejecting apparatus with such a configuration, since the nipping member can be formed as a single component, it is possible to damp the vibration of the fluid absorbing member with the simpler and easier configuration.

In the fluid ejecting apparatus, the nipping member may nip the fluid absorbing member in a slit between two plate members.

According to the fluid ejecting apparatus with such a configuration, since the nipping member is formed from a plurality of components, the slit width or the like can be adjusted, and hence the friction resistance can be easily adjusted.

In the fluid ejecting apparatus, the vibration suppressing member may be a support portion elastically supporting a pulley around which the fluid absorbing member is wound.

According to the fluid ejecting apparatus with such a configuration, the vibration of the fluid absorbing member is transmitted to the support portion via the pulley, whereby the support portion is elastically deformed. As a result, the restoring force of the support portion is transmitted to the fluid absorbing member via the pulley, so that the vibration of the fluid absorbing member can be damped.

Therefore, according to the fluid ejecting apparatus, it is possible to damp the vibration of the fluid absorbing member with a simple and easy configuration.

### BRIEF DESCRIPTION OF THE DRAWINGS

The invention will be described with reference to the accompanying drawings, wherein like numbers reference like elements.

FIG. 1 is a perspective view illustrating a schematic configuration of a printer of the first embodiment of the invention.

FIG. 2 is a perspective view illustrating a lower surface side of a head unit provided in the printer of the first embodiment of the invention.

FIG. 3 is a perspective view illustrating the head unit and the flushing unit provided in the printer of the first embodiment of the invention when seen from the lower side thereof.

FIG. 4 is a schematic diagram illustrating the head unit and the flushing unit provided in the printer of the first embodiment of the invention when seen from the transportation direction of the printing sheet.

FIGS. 5A and 5B are schematic diagrams illustrating an example of an absorbing member provided in the printer of the first embodiment of the invention.

FIG. 6 is a front view illustrating a movement member provided in the printer of the first embodiment of the invention.

FIGS. 7A and 7B are explanatory diagrams illustrating a flushing position and a retreat position of the printer of the first embodiment of the invention.

FIG. 8 is a flowchart illustrating an operation involved with a flushing process of the printer of the first embodiment of the invention.

FIG. 9 is a schematic diagram illustrating the head unit and the flushing unit provided in the printer of the second embodiment of the invention when seen from the transportation direction of the printing sheet.

FIG. 10 is a side view illustrating a nipping member provided in the printer of the second embodiment of the invention.

FIG. 11 is a side view illustrating a modified example of the nipping member provided in the printer of the second embodiment of the invention.

FIG. 12 is a schematic diagram illustrating the head unit and the flushing unit provided in the printer of the third embodiment of the invention when seen from the transportation direction of the printing sheet.

### DESCRIPTION OF EXEMPLARY EMBODIMENTS

Hereinafter, an embodiment of a fluid ejecting apparatus according to the invention will be described with reference to the accompanying drawings. Further, in the drawings below, the scales of the respective members are appropriately changed so that the respective members have recognizable sizes. Furthermore, in the description below, an ink jet printer (hereinafter, simply referred to as a printer) as an example of the fluid ejecting apparatus of the invention will be described.

### First Embodiment

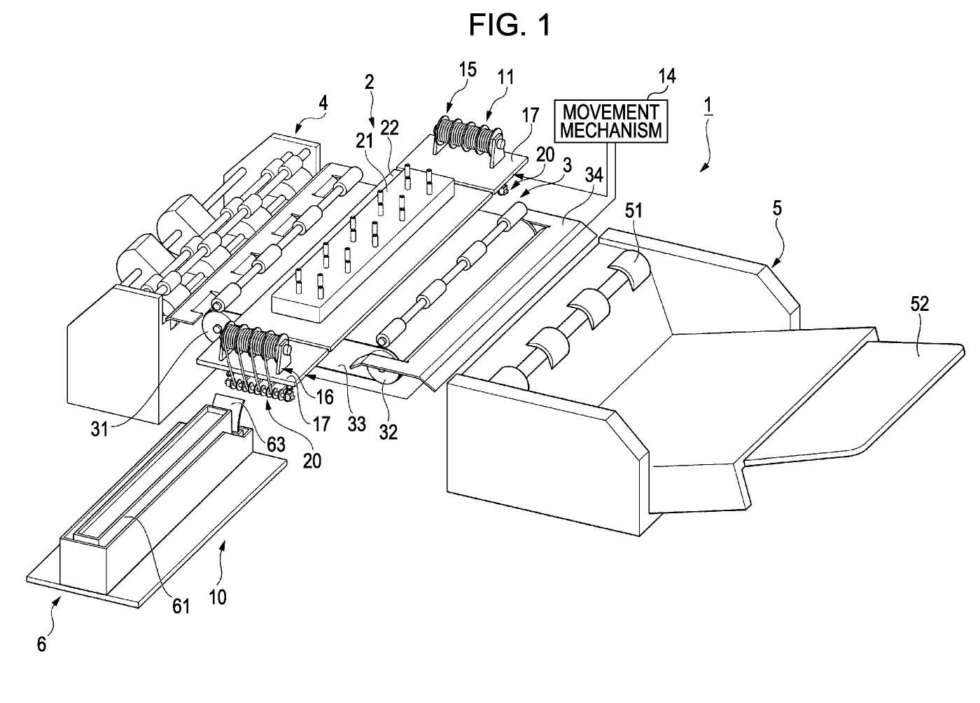

FIG. 1 is a perspective view illustrating a schematic configuration of a printer 1 of this embodiment of the invention. As illustrated in this drawing, the printer 1 of this embodiment includes a head unit 2, a transportation device 3 which transports a printing sheet (medium), a sheet feeding unit 4 which supplies the printing sheet, a sheet discharging unit 5 which discharges the printing sheet printed by the head unit 2, and a maintenance device 10 which performs a maintenance process on the head unit 2.

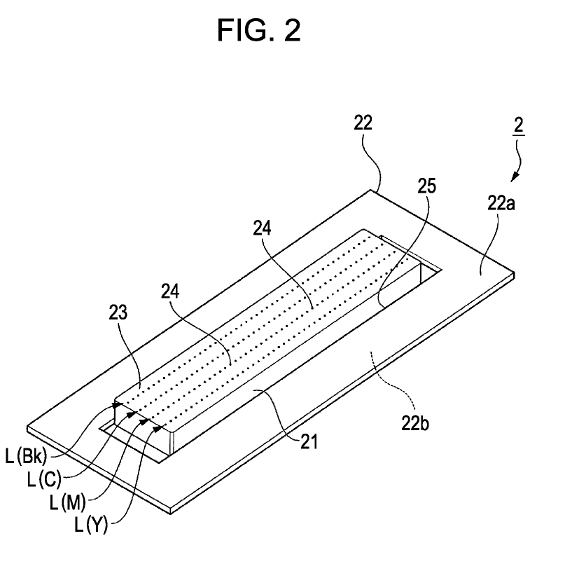

The transportation device 3 holds the printing sheet while having a predetermined gap with respect to the nozzle surface 23 (refer to FIG. 2) of the printing head 21 constituting the head unit 2. The transportation device 3 includes a driving roller portion 31, a driven roller portion 32, and a transportation belt portion 33 which is formed by a plurality of belts wound around the roller portions 31 and 32. In addition, a holding member 34 for holding the printing sheet is installed between the sheet discharging unit 5 and the downstream side (the side of the sheet discharging unit 5) of the transportation direction of the printing sheet of the transportation device 3.

One end of the driving roller portion 31 in the rotation direction is connected to a driving motor (not shown), and is rotationally driven by the driving motor. The rotation force of the driving roller portion 31 is transmitted to the transporting belt portion 33, so that the transporting belt portion 33 is rotationally driven. If necessary, a transmission gear is provided between the driving roller portion 31 and the driving motor. The driven roller portion 32 is a so-called free roller which supports the transporting belt portion 33 and is rotated by the rotational driving operation of the transporting belt portion 33 (the driving roller portion 31).

The sheet discharging unit 5 includes a sheet discharging roller 51 and a sheet discharging tray 52 which holds the printing sheet transported by the sheet discharging roller 51.

FIG. 2 is a perspective view illustrating the lower surface side of the head unit 2. As illustrated in this drawing, the head unit 2 includes a linear printing head 21 (fluid ejecting head) and an attachment plate 22 supporting the printing head 21.

The printing head 21 is formed in accordance with the effective printing width of the head unit 2, and includes a plurality of nozzles 24 ejecting ink. In addition, the nozzles 24 ejecting the same kind (for example, black B, magenta M, yellow Y, and cyan C) of ink are arranged in the extension direction of the printing head 21 to thereby form one nozzle row L. That is, the printer 1 of this embodiment includes the printing head 21 having nozzle rows L formed by the plurality of nozzles 24 ejecting ink.

In more detail, the printing head 21 has four nozzle rows (L(Y), L(M), L(C), and L(Bk)) corresponding to four colors (yellow (Y), magenta (M), cyan (C), and black (Bk)). As for each of the nozzle rows (L(Y), L(M), L(C), and L(Bk)), the nozzles 24 forming the corresponding nozzle rows (L(Y), L(M), L(C), and L(Bk)) are arranged in the horizontal direction intersecting the transportation direction of the printing sheet, and more desirably arranged in the horizontal direction perpendicular to the transportation direction of the printing sheet.

As illustrated in FIG. 2, the head unit 2 has a structure in which the printing head 21 is disposed inside an opening 25 formed in the attachment plate 22. In detail, the printing head 21 is fixed to a rear surface 22b of the attachment plate 22 by the use of a screw, so that the nozzle surface 23 protrudes from a front surface 22a of the attachment plate 22 via the opening 25. In addition, since the attachment plate 22 is fixed to a carriage (not shown), the head unit 2 is adapted to be movable to a maintenance position to be described later.

The head unit 2 of this embodiment is adapted to be movable between the printing position and the maintenance position by the use of a carriage (not shown). Here, the printing position is a position where the head unit performs a printing process on the printing sheet while facing the transportation device 3. On the other hand, the maintenance position is a position where the head unit faces a cap unit 6 (refer to FIG. 1) provided in the maintenance device 10 at a position retreating from the upper side of the transportation device 3. The maintenance process (a suction process and a wiping process) for the head unit 2 is performed at the maintenance position.

Returning to FIG. 1, the maintenance device 10 includes the cap unit 6 which performs the suction process on the head unit 2, and a flushing unit 11 which performs a flushing process on the head unit 2.

The cap unit 6 performs the maintenance process such as a capping or suction operation on the head unit 2, and includes a cap portion 61 corresponding to the printing head 21. The cap unit 6 is disposed at a position deviated from a printing area of the head unit 2.

The cap portion 61 is adapted to come into contact with the nozzle surface 23 of the printing head 21. Since the cap portion 61 comes into close contact with the nozzle surface 23 of the printing head 21, it is possible to perform a satisfactory capping operation, and also to perform a satisfactory suction operation of discharging ink from the nozzle surface 23.

In addition, as illustrated in FIG. 1, the cap unit 6 includes a wiper member 63 which is used in a wiping process of wiping the nozzle surface 23 of the printing head 21.

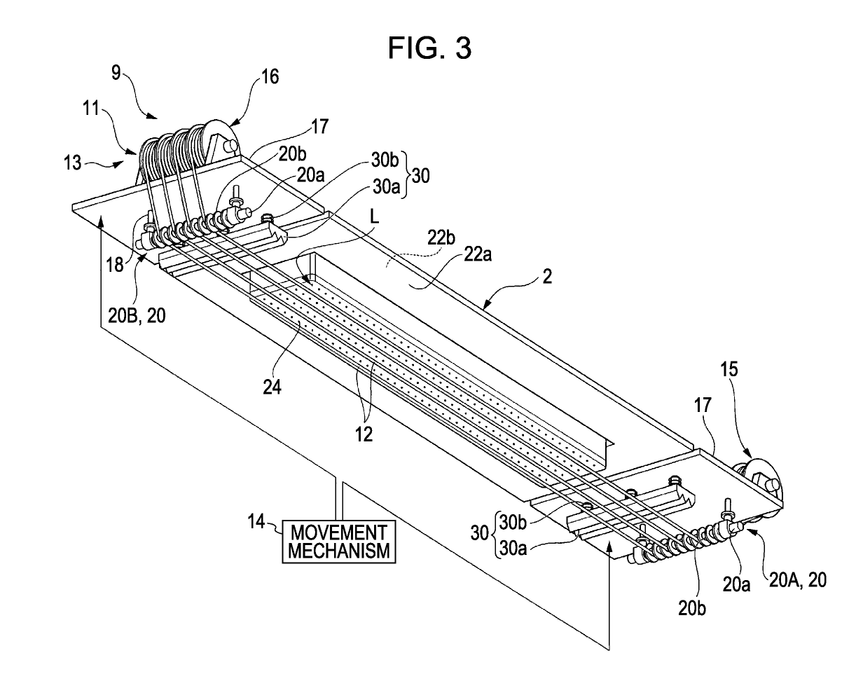

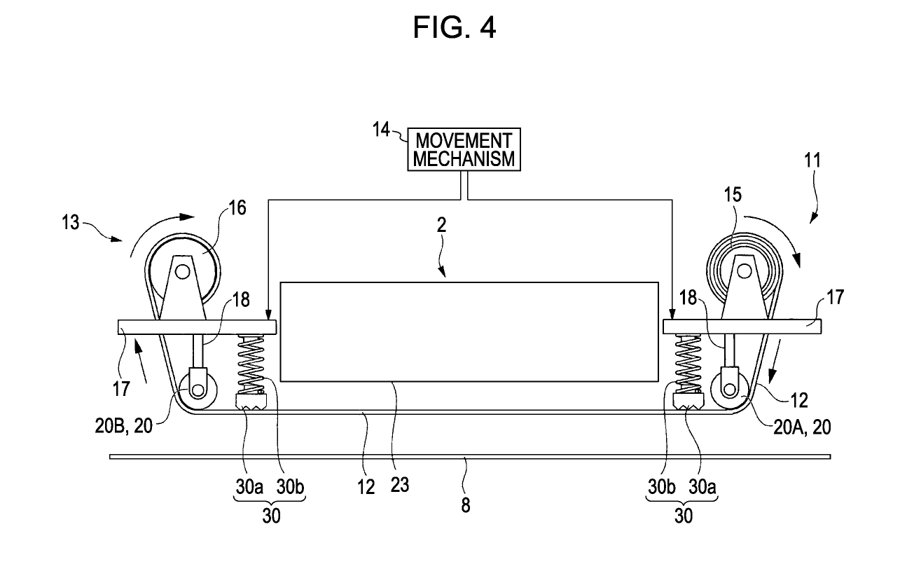

FIG. 3 is a perspective view illustrating the head unit 2 and the flushing unit 11 when seen from the lower side thereof. In addition, FIG. 4 is a schematic diagram illustrating the head unit 2 and the flushing unit 11 when seen from the transportation direction of the printing sheet.

As illustrated in these drawings, the flushing unit 11 includes a plurality of absorbing members 12 (fluid absorbing members) which absorbs ejected ink during the flushing process, a support mechanism 9 which supports the plurality of absorbing members 12, and a vibration suppressing portion 30 which damps vibration of the absorbing member 12.

The absorbing member 12 is a linear member which absorbs ink ejected from each of the nozzles 24, and four absorbing members 12 are installed for each head unit 2. The absorbing members 12 extend respectively along the nozzle rows (L(Y), L(M), L(C), and L(Bk)) formed by the nozzles 24 of respective colors, and are located between the nozzle surface 23 and the transportation area of the printing sheet.

Next, the detailed configuration of the absorbing member 12 suitably used in the printer 1 according to this embodiment will be described.

For example, the absorbing member 12 may be formed of fiber such as SUS 304, nylon, nylon applied with a hydrophobic coating, aramid, silk, cotton, polyester, ultrahigh molecular weight polyethylene, polyarylate, or Zylon (product name), or compound fiber containing a plurality of these.

In more detail, it is possible to form the absorbing member 12 in such a manner that plural fiber bundles formed of the fiber or the compound fiber are twisted or bound.

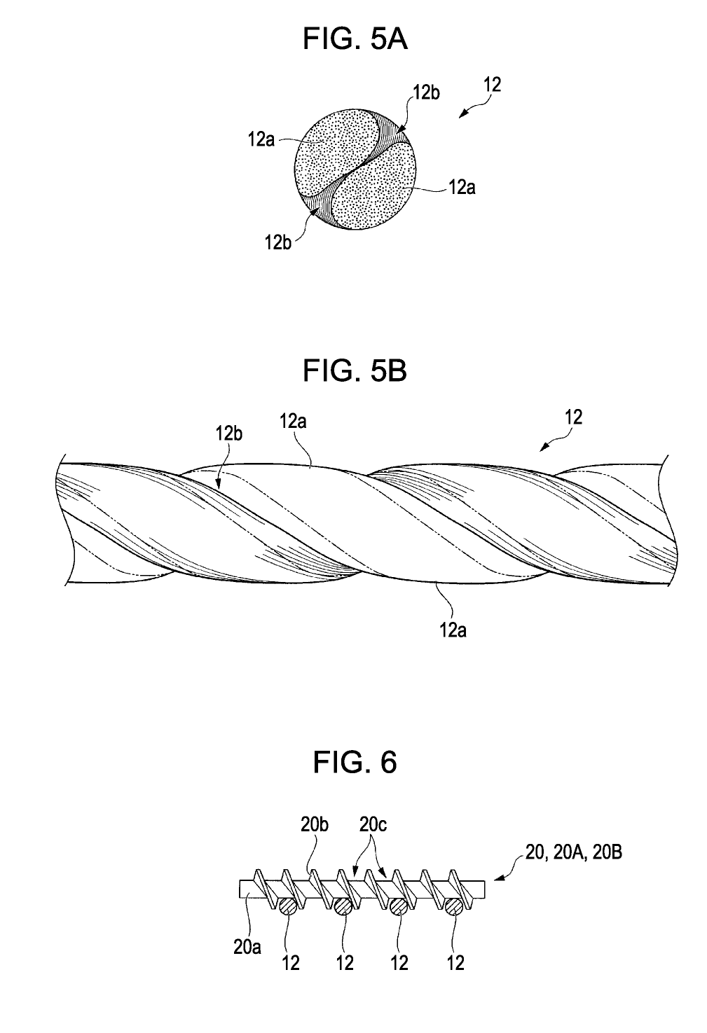

FIGS. 5A and 5B are schematic diagrams showing an example of the absorbing member 12, where FIG. 5A is a sectional view and FIG. 5B is a plan view. As shown in FIGS. 5A and 5B, for example, the absorbing member 12 is formed in such a manner that two (plural) fiber bundles (strings) 12a formed of fiber are twisted. As shown in FIGS. 5A and 5B, in the case where the absorbing member 12 is formed by twisting the plural fiber bundles 12a, since it is possible to store ink in a valley portion 12b formed between the fiber bundles 12a, it is possible to increase an ink absorption amount of the absorbing member 12.

In addition, as an example, a linear member obtained by twisting plural fiber bundles formed of SUS 304, a linear member obtained by twisting plural fiber bundles formed of nylon, a linear member obtained by twisting plural fiber bundles formed of nylon applied with hydrophobic coating, a linear member obtained by twisting plural fiber bundles formed of aramid, a linear member obtained by twisting plural fiber bundles formed of silk, a linear member obtained by twisting plural fiber bundles formed of cotton, a linear member obtained by twisting plural fiber bundles formed of Belima (product name), a linear member obtained by twisting plural fiber bundles formed of Soierion (product name), a linear member obtained by twisting plural fiber bundles formed of Hamilon 03 T (product name), a linear member obtained by twisting plural fiber bundles formed of Dyneema hamilon DB-8 (product name), a linear member obtained by twisting plural fiber bundles formed of Vectran hamilon VB-30, a linear member obtained by twisting plural fiber bundles formed of Hamilon S-5 Core Kevlar Sleeve Polyester (product name), a linear member obtained by twisting plural fiber bundles formed of Hamilon S-212 Core Coupler Sleeve Polyester (product name), a linear member obtained by twisting plural fiber bundles formed of Hamilon SZ-10 Core Zylon Sleeve Polyester (product name), or a linear member obtained by twisting plural fiber bundles formed of Hamilon VB-3 Vectran (product name) may be suitably used as the absorbing member 12.

Since the absorbing member 12 obtained by the fiber of nylon is formed of nylon widely used as a general leveling string, the absorbing member 12 is cheap.

Since the absorbing member 12 using the metallic fiber of SUS has an excellent corrosion resistance property, it is possible to allow the absorbing member 12 to absorb a variety of ink. Also, since the absorbing member 12 has an excellent wear resistance property compared with a resin, it is possible to repeatedly use the absorbing member 12.

The absorbing member 12 using the fiber of ultrahigh molecular weight polyethylene has high breaking strength and chemical resistance, and is strong against an organic solvent, acid, or alkali. Likewise, since the absorbing member 12 using the fiber of ultrahigh molecular weight polyethylene has high breaking strength, it is possible to pull the absorbing member 12 in a high-tension state, and to prevent the absorbing member 12 from being bent. For this reason, in the case where the diameter of the absorbing member 12 is thickened so as to increase the absorbing capacity or the diameter of the absorbing member 12 is not thickened, it is possible to improve the printing precision by narrowing the distance between the printing sheet transporting region and the head 21. In addition, it is expected that the above-described advantage is obtained even in the absorbing member 12 using the fiber of Zylon or an aramid and the absorbing member 12 using the fiber of super-high-molecular polyethylene.

The absorbing member 12 using the fiber of cotton has an excellent ink absorbing property.

In the absorbing member 12, the dropped ink is accommodated and absorbed in the valley portion 12b (see FIGS. 5A and 5B) formed between the fiber bundle 12a and the fiber due to the surface tension.

In addition, a part of the ink dropped onto the surface of the absorbing member 12 directly enters into the absorbing member 12, and the rest moves to the valley portion 12b formed between the fiber bundles 12a. Further, a part of the ink entering into the absorbing member 12 gradually moves in the extension direction of the absorbing member 12 in the inside of the absorbing member 12 so as to be held therein while being dispersed in the extension direction of the absorbing member 12. A part of the ink moving to the valley portion 12b of the absorbing member 12 gradually enters into the absorbing member 12 through the valley portion 12b, and the rest remains in the valley portion 12b so as to be held therein while being dispersed in the extension direction of the absorbing member 12. That is, a part of the ink dropped onto the surface of the absorbing member 12 stays at the dropped position, and the rest is dispersed and absorbed in the vicinity of the dropped position.

In addition, in fact, a material forming the absorbing member 12 provided in the printer 1 is selected in consideration of an ink absorbing property, an ink holding property, a tensile strength, an ink resistance property, formability (a generated amount of fluff or fraying), distortion, cost, or the like.

Further, the ink absorbing amount of the absorbing member 12 is the sum of the amount of ink held between the fibers of the absorbing member 12 and the amount of ink held in the valley portion 12b. For this reason, the material forming the absorbing member 12 is selected so that the ink absorbing amount is sufficiently larger than the amount of the ink ejected during the flushing process in consideration of the exchange frequency of the absorbing member 12.

Furthermore, the amount of ink held between the fibers of the absorbing member 12 and the amount of ink held in the valley portion 12b may be determined by the contact angle between the ink and the fibers, and the capillary force between the fibers depending on the surface tension of the ink. That is, when the absorbing member 12 is formed of thin fibers, the gap between the fibers increases and the surface area of the fiber increases. Accordingly, even when the sectional area of the absorbing member 12 is uniform, the absorbing member 12 is capable of absorbing a larger amount of ink. As a result, in order to obtain more gaps between the fibers, a micro fiber (ultrafine fiber) may be used as a fiber forming the fiber bundle 12a.

However, the ink holding force of the absorbing member 12 decreases since the capillary force decreases due to an increase in the gap between the fibers. For this reason, it is necessary to set the gap between the fibers so that the ink holding force of the absorbing member 12 is of a degree that the ink is not dropped due to the movement of the absorbing member 12.

In addition, the thickness of the absorbing member 12 is set so as to satisfy the above-described ink absorbing amount. In detail, for example, the thickness of the absorbing member 12 is set to be equal to or more than 0.3 mm and equal to or less than 1.0 mm, and more desirably about 0.5 mm.

However, in order to prevent the absorbing member 12 from coming into contact with the head 21 and the printing sheet, the thickness of the absorbing member 12 is set so that the maximum dimension of the section is equal to or less than a dimension obtained by subtracting an amount excluding the displacement amount caused by the bending of the absorbing member 12 from the distance of the sheet transporting region between the printing sheet and the head 21.

In addition, the absorbing member 12 has a width which is larger than the diameter of the nozzle by 15 to 50 times. In this embodiment, the gap between the printing sheet and the nozzle surface 23 of the printing head 21 is about 2 mm, and the nozzle diameter is about 0.02 mm. Accordingly, when the diameter of the absorbing member 12 is 1 mm or less, the absorbing member can be disposed between the nozzle surface and the printing sheet, and the ejected ink can be captured by the absorbing member even when component errors are considered.

In addition, it is desirable that the length of the absorbing member 12 is sufficiently long with respect to the effective printing width of the head unit 2. As described later in detail, in the printer 1 of this embodiment, when the ink is absorbed to the entire area of the absorbing member 12 in a manner that the used-up area (which cannot absorb the ink any more) of the absorbing member 12 is sequentially wound, the absorbing member 12 is exchanged with a replacement when the ink is absorbed to the entire area of the absorbing member 12. For this reason, the exchange period of the absorbing member 12 needs to be set to the time that the absorbing member can be used in the practical application, and desirably the length of the absorbing member 12 needs to be longer by about several hundreds of times than the effective printing width of the head unit 2. However, when the absorbing member 12 is recycled by the cleaning process inside the printer 1, the length of the absorbing member 12 is preferably slightly longer by about twice than the effective printing width of the head unit 2.

Then, the absorbing member 12 is supported by the support mechanism 9.

As illustrated in FIGS. 3 and 4, the support mechanism 9 includes a movement mechanism 13 and a movement mechanism 14.

The movement mechanism 14 moves the absorbing member 12 between the flushing position opposite the nozzle 24 and the retreat position not opposite the nozzle 24 by moving the absorbing member 12 in the direction (in this embodiment, perpendicular to) intersecting the extension direction of the nozzle row. In addition, the movement mechanism 13 moves the absorbing member 12 to flow along the extension direction of the nozzle row.

As illustrated in FIGS. 3 and 4, the movement mechanism 13 includes rotation portions 15 and 16 which are respectively provided in both sides of the head unit 2 in the nozzle arrangement direction to be fixed to the side of the rear surface 22b (the opposite side of the nozzle surface 23 of the printing head 21) of the attachment plate 22 so that their rotation shafts are parallel to the transportation direction of the printing sheet. The rotation portions 15 and 16 constitute a winding mechanism which is formed in a bobbin shape with a plurality of partition plates arranged at the same interval, where each of the absorbing members 12 is wound between the partition plates, and in total four absorbing members 12 can be wound around the winding mechanism.

Then, the rotation portions 15 and 16 are installed on the support plate 17 installed inside the casing of the printer 1.

The rotation portions 15 and 16 are connected to a driving motor (not shown), and the plurality of absorbing members 12 is supplied and wound by the rotation thereof. In this embodiment, one rotation portion 15 is used to supply the absorbing members 12 therefrom, and the other rotation portion 16 is used to wind the absorbing members 12 thereon.

The movement mechanism 14 moves the absorbing members 12 of the rotation portions 15 and 16 in the transportation direction of the printing sheet (the direction perpendicular to the extension direction of the nozzle row) by moving the support plate 17 in the transportation direction of the printing sheet while supporting the support plate 17. An example of the movement mechanism 14 includes a linear slide device.

In addition, the support mechanism 9 includes a pulley 20 which is axially fixed to the rear surface (the surface opposite to the surface provided with the rotation portions 15 and 16) of the support plate 17.

The pulley 20 has a structure in which a convex portion 20b is wound around a shaft portion 20a, and is installed for each support plate 17 (pulleys 20A and 20B). As illustrated in FIG. 6, each of the absorbing members 12 is held inside a guide groove 20c formed by the shaft portion 20a and the convex portion 20b.

Then, as illustrated in FIGS. 3 and 4, the pulleys 20A and 20B are installed on the support plate 17 via shaft support portions 18, and are disposed on both sides of the head unit 2 in the nozzle arrangement direction to be fixed to the side of the front surface 22a of the attachment plate 22 (the nozzle surface 23 of the printing head 21). The plurality of absorbing members 12 wound and suspended on the rotation portions 15 and 16 of the movement mechanism 13 are bridged between the pulleys 20A and 20B. Then, the end of the guide groove 20c in the direction perpendicular to the nozzle surface 23 is located in a direction moving away from the nozzle surface 23 with respect to the nozzle surface 23. For this reason, the absorbing members 12 bridged between the pulleys 20A and 20B are held without contacting the nozzle surface 23 of the printing head 21.

In addition, the support mechanism 9 holds the plurality of absorbing members 12 at an appropriate tension in order not to curve the absorbing members in a manner that the rotation speeds of the rotation portions 15 and 16 are respectively controlled by a control device (not shown). Accordingly, it is possible to prevent the absorbing members 12 from being curved to contact the nozzle surface 23 or the printing sheet.

In such a support mechanism 9, since the plurality of absorbing members 12 is supported by the rotation portions 15 and 16 disposed on the support plate 17 and the pulleys 20A and 20B disposed on the front surface 22a of the attachment plate 22, each of the absorbing members 12 is supplied from the rotation portion 15, and is wound around the rotation portion 16 while passing on the nozzle surface 23 of the printing head 21. For this reason, the absorbing member 12 is moved in the extension direction of each nozzle row L of the head unit 2, that is, the direction intersecting the transportation direction of the printing sheet in accordance with the rotation of the rotation portions 15 and 16.

In addition, since the support plate 17 is moved in the transportation direction of the printing sheet by the movement mechanism 14, it is possible to change the position of each of the absorbing members 12 with respect to the head unit 2 (nozzle row L). Specifically, in this embodiment, the absorbing member 12 is moved between the flushing position and the retreat (printing) position.

Further, if the diameter of the absorbing member 12 is set to 1 mm, the absorbing member 12 can be located to avoid the flying path of the ink on the outside even when the absorbing member is moved by 1 mm under the condition that there are component dimension errors or arrangement errors. For this reason, the time taken for the movement of the absorbing member 12 may be shortened. In addition, since the distance between the printing head 21 and the printing sheet is 2 mm, and the absorbing member 12 is disposed in a tensioned state therebetween, the printing head 21 and the printing sheet do not need to be moved during the movement of the support plate 17 using the movement mechanism 14.

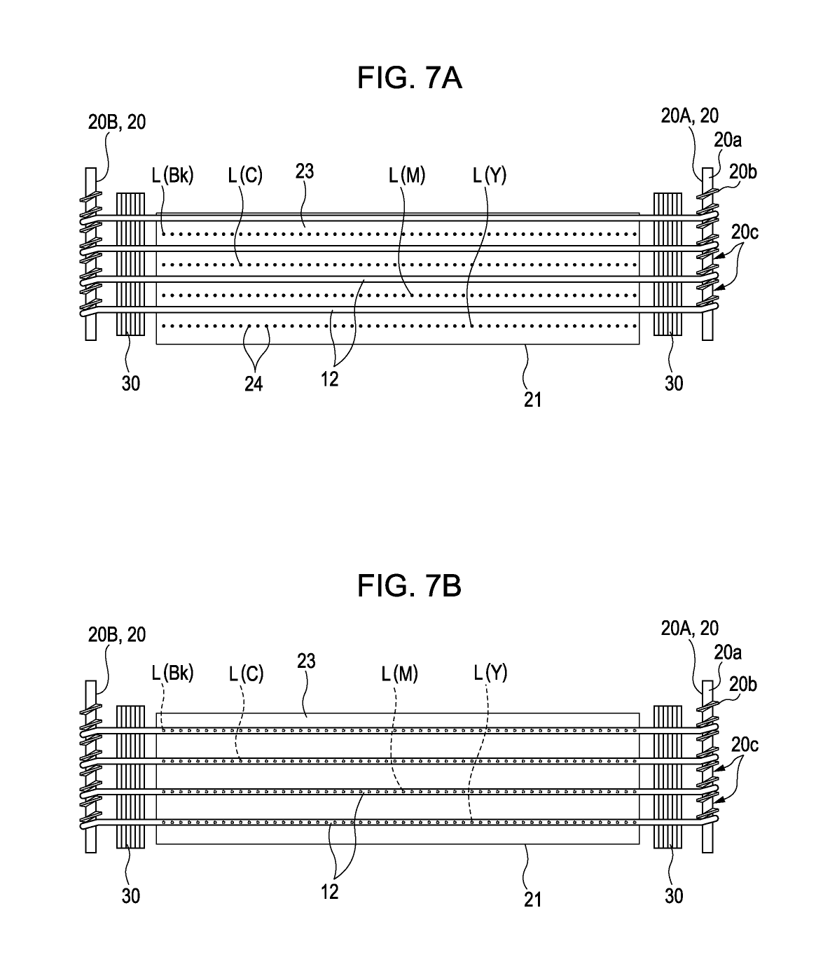

Further, as illustrated in FIG. 7B, the flushing position indicates a position (a position on the flying path of the ink) where the inks ejected from the nozzle rows L during the flushing process can be absorbed by the absorbing members 12 in the state where the absorbing members are disposed directly below the plurality of corresponding nozzle rows L (the plurality of nozzles 24 constituting the nozzle rows L). On the other hand, as illustrated in FIG. 7A, the retreat position of the absorbing member 12 indicates a position where the inks ejected from the nozzles 24 during the printing process cannot be absorbed by the absorbing members 12 in the state where the absorbing members 12 do not face the nozzle rows L (the plurality of nozzles 24 constituting the nozzle rows L).

As illustrated in FIGS. 7A and 7B, all the absorbing members 12 are moved by the movement of the pulley 20 in accordance with the movement of the support plate 17. Then, each of the absorbing members 12 of the printer 1 of this embodiment is disposed between the printing sheet and the nozzle surface of the printing head 21 in the transportation direction of the printing sheet not only at the flushing position, but also at the retreat position.

Returning to FIGS. 3 and 4, the vibration suppressing portion 30 is used to damp vibration of the absorbing member 12 as described above, and a plurality of the vibration suppressing portions is disposed in an area where the head unit 2 is not disposed so that the head unit 2 is interposed therebetween in the transportation direction of the printing sheet.

The vibration suppressing portion 30 includes a contact portion 30a which comes into contact with the absorbing member 12, and a spring 30b (elastic body) which connects the contact portion 30a and the support plate 17 to each other.

The contact portion 30a may be provided for each of the absorbing members 12, or only one contact portion 30a may be provided for the plurality of absorbing members 12. However, the contact portion 30a is installed so that all the absorbing members 12 come into contact with the contact portion 30a.

The spring 30b is connected to the contact portion 30a, and is used to damp the vibration of the absorbing member 12 by its elastic deformation.

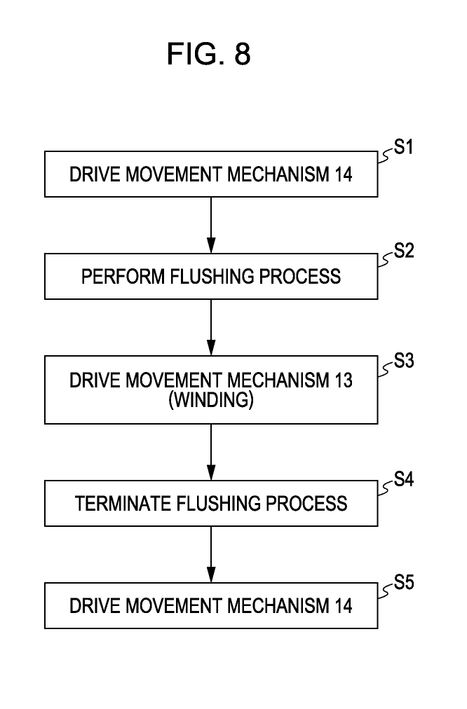

Next, the operation of the printer 1 of this embodiment involved with the flushing process will be described with reference to the flowchart shown in FIG. 8. In addition, the operation of the printer 1 of this embodiment is generally controlled by a control device (not shown).

The printer 1 starts the flushing process on the basis of a predetermined instruction.

First, the control device moves the plurality of absorbing members 12, which is supported by the support mechanism, to the flushing position by driving the movement mechanism 14 (step S1). Specifically, each of the absorbing members 12 is disposed directly below each of the nozzle rows L of the printing head 21 by moving the support plate 17 in the transportation direction of the printing sheet using the movement mechanism 14. At this time, the absorbing members 12 are made to face the plurality of nozzle rows L arranged in the arrangement direction of the printing head 21.

In this manner, four absorbing members 12 are made to be located in the ink ejection direction (flying path) of the nozzle rows L.

Subsequently, the control device performs the flushing process on the head unit 2 (S2 in FIG. 8) so as to eject ink droplets (for example, 10 droplets) from the nozzle rows L (the nozzles 24) of the printing head 21 to the absorbing members 12. The ink droplets ejected from the nozzle rows L are absorbed by the absorbing members 12.

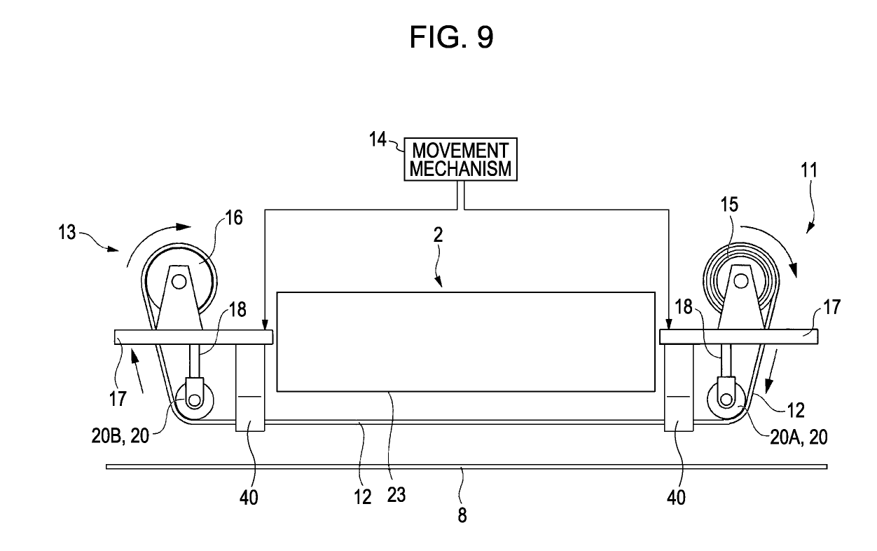

The control device drives the moving mechanism 13 and moves each of the absorbing members 12 in a direction depicted by the arrow in FIG. 9 during a time when the flushing process is performed on the head unit 2 so as to perform an operation of winding the ink absorbing portion of the absorbing member 12 (S3 in FIG. 8). That is, in the printer 1 according to this embodiment, the moving mechanism 13 moves the absorbing member 12 in the extension direction during the flushing process under the control of the control device. Accordingly, since the ink droplets ejected from the nozzle rows L are ejected onto a new portion not containing the ink of the absorbing member 12, the ink droplets are reliably and rapidly absorbed into the absorbing member 12.

In addition, in the case where the maximum dimension of the section of the absorbing member 12, of 75 times larger than the diameter of the nozzle, is used, the ink absorbing capacity of the absorbing member 12 is very high. For this reason, it is not necessary to perform the operation of winding the absorbing member 12 while performing the flushing process. For example, in the case where the ink is not dropped even when 100 droplets of ink are ejected onto the same position of the absorbing member 12, a new portion of the absorbing member 12 may be supplied after performing the flushing process 10 times.

That is, in the printer 1 according to this embodiment, the moving mechanism 13 may move the absorbing member after performing the flushing process plural times. Accordingly, the same region of the absorbing member 12 is used to receive the ink droplets plural times, and hence the absorbing member 12 is capable of absorbing a large amount of ink.

In this embodiment, the moving mechanism 13 controls the winding speed of the absorbing member 12 in accordance with the amount of ejected ink. When the amount of ejected ink is large, the winding speed increases so that the absorbing member 12 is not saturated, and the absorbing member 12 is wound at a high speed so as to prevent a case where the ink is not absorbed.

When the flushing process ends (step S4), the control device moves the plurality of absorbing members 12 to the retreat position by driving the movement mechanism 14 (step S5). Specifically, the absorbing member 12 facing the nozzle row L is made to retreat from the position facing the nozzle 12 by moving the support plate 17 in the transportation direction of the printing sheet using the movement mechanism 14. Further, the aforementioned winding operation may be performed after the retreat.

Subsequently, the control device restarts the printing process performed on the printing sheet.

Then, after performing the flushing process plural times during the printing process, when most of the absorbing member 12 wound around the rotation portion 15 of the moving mechanism 13 is wound around the rotation portion 16, and the absorbing member 12 cannot be supplied any more to the rotation portion 16, the absorbing member 12 is exchanged with a replacement. As illustrated in FIG. 9, since the moving mechanism 13 according to this embodiment is detachably attached to the rear surface 22b of the attachment plate 22 through the attachment member 70, it is possible to easily exchange the absorbing member 12.

According to this embodiment, since the linear absorbing member 12 is disposed between the printing sheet 8 and the printing head 21, and the linear absorbing member 12 is moved so as to face the nozzle of the printing head 21 and to absorb ink during the flushing process, it is possible to perform the flushing process without moving the head unit 2. Since it is not necessary to move the head unit 2, it is possible to rapidly perform the flushing process at the appropriate timing.

In addition, since the absorbing member 12 is a thin linear member, the absorbing member 12 can be disposed at a corresponding position between the nozzle rows during the printing process. Accordingly, since the movement distance of the absorbing member 12 is shortened, the movement thereof can be completed in a short time.

Further, since the linear member is used as the absorbing member 12, it is possible to prevent a rising air stream from being generated in the vicinity of the absorbing member 12 and to prevent the ink from being attached to the head 21 when the ink is dropped onto the absorbing member 12. For this reason, it is possible to move the absorbing member 12 to be close to the head 21, and to suppress the occurrence of mist caused by the volatilization of ink and contaminating the head 21 or the like.

Furthermore, since the ejection target is the linear absorbing member 12 during the flushing process, dot omission due to the influence of wind pressure generated upon ejecting ink to the absorbing member 12 rarely occurs. In addition, since all the ink droplets ejected during the flushing process are absorbed by the absorbing member 12 in the vicinity of the nozzle 24, it is possible to prevent the printing sheet or the transporting belt portion 33 from being contaminated.

Moreover, since the winding speed of the absorbing member 12 is changed in accordance with the amount of ejected ink, it is possible to perform the operation of winding the absorbing member 12 during a period when the absorbing member 12 is not saturated by the ink. Accordingly, it is possible to absorb the ink reliably into the absorbing member 12 without ink leakage during the flushing process.

As described above, in this embodiment, since it is possible to rapidly perform the flushing process with a simple configuration, it is possible to improve the printing performance.

In the procedure of the flushing process described above, the absorbing member 12 may be vibrated in some cases due to the movement of the movement mechanisms 13 and 14 or the operation of receiving the ink ejected from the nozzle 24.

In the printer 1 of this embodiment, when the absorbing member 12 is vibrated as described above, the vibration is damped by the vibration suppressing portion 30.

More specifically, the vibration of the absorbing member 12 is transmitted to the spring 30b via the contact portion 30a coming into contact with the absorbing member 12, and hence the spring 30b is elastically deformed. As a result, the restoring force of the spring 30b is transmitted to the absorbing member 12 via the contact portion 30a, so that the vibration of the absorbing member 12 can be damped.

Likewise, since the vibration of the absorbing member 12 is damped, it is possible to suppress the absorbing member 12 from deviating from an area which is directly below the nozzle 24 and in which the ink thereof can be received. Therefore, according to the printer 1 of this embodiment, it is possible to receive the ink reliably using the absorbing member 12 during the flushing process.

As described above, the printer 1 of this embodiment includes the vibration suppressing portion 30 that damps the vibration of the absorbing member 12. For this reason, the vibration of the absorbing member 12 is damped by the vibration suppressing portion 30. Accordingly, it is possible to suppress the absorbing member 12 from deviating from an area which is directly below the nozzle 24 of the printing head 21 and in which the ink thereof can be received.

Therefore, according to the printer 1 of this embodiment, even when the absorbing member 12 is formed in a linear shape, it is possible to reliably receive the ink using the absorbing member 12 during the flushing process.

Further, in the printer 1 of this embodiment, the vibration suppressing portion 30 includes the contact portion 30a which comes into contact with the absorbing member 12, and the spring 30b (elastic body) which connects the contact portion 30a and the support plate 17 to each other.

For this reason, according to the printer 1 of this embodiment, it is possible to damp the vibration of the absorbing member 12 with a simple and easy configuration.

### Second Embodiment

Next, the second embodiment of the invention will be described. Further, in the description of the second embodiment, the description of the same components as those of the first embodiment will be omitted or simplified.

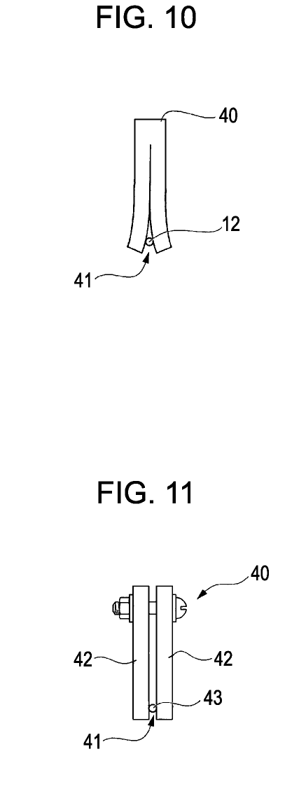

FIG. 9 is a schematic diagram illustrating the head unit 2 and the flushing unit 11 provided in the printer of this embodiment when seen from the transportation direction of the printing sheet. In addition, FIG. 10 is a side view illustrating a nipping member 40 (vibration suppressing means) provided in the printer of this embodiment when seen from the extension direction of the absorbing member 12.

As illustrated in FIG. 9, the printer of this embodiment includes the nipping member 40 instead of the vibration suppressing portion 30 provided in the printer 1 of the first embodiment.

The nipping member 40 is used to damp the vibration of the absorbing member 12. That is, the nipping member 40 movably nips the absorbing member 12, and damps the vibration of the absorbing member 12 by the use of friction resistance generated between the absorbing member 12 and the nipping member 40.

As illustrated in FIG. 10, the nipping member 40 has a shape which branches downwards into two pieces, and the absorbing member 12 is nipped in the slit 41 formed therebetween.

In the printer of this embodiment with such a configuration, when the absorbing member 12 is vibrated, the absorbing member 12 slides on the nipping member 40. As a result, friction resistance is generated between the absorbing member 12 and the nipping member 40, which damps the vibration of the absorbing member 12.

Therefore, according to the printer of this embodiment, it is possible to damp the vibration of the absorbing member 12 with a simple and easy configuration.

Further, in the printer of this embodiment, the absorbing member 12 is nipped in the slit 41 formed by dividing the nipping member 40 into two pieces.

For this reason, since the nipping member can be formed as a single component, it is possible to damp the vibration of the absorbing member 12 with the easier and simpler configuration.

In addition, the configuration of the nipping member 40 is not limited to the configuration of this embodiment, but for example, as illustrated in FIG. 11, a configuration may be adopted in which the absorbing member 12 is nipped in a slit 43 formed between two plate members 42.

When the nipping member 40 adopts such a configuration, the nipping member 40 is formed as a plurality of components. However, since the width or the like of the slit 43 can be adjusted, the friction resistance can be easily adjusted.

### Third Embodiment

Next, the third embodiment of the invention will be described. Further, in the description of the third embodiment, the description of the same components as those of the first embodiment will be omitted or simplified.

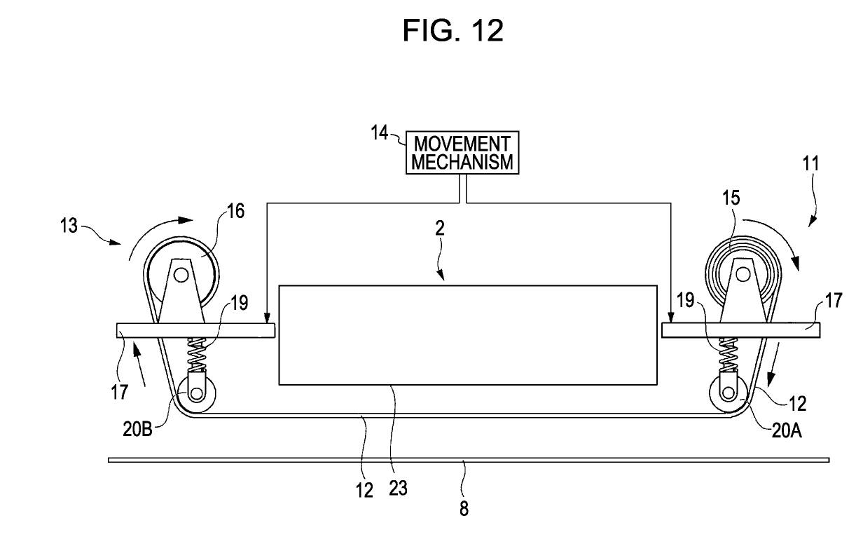

FIG. 12 is a schematic diagram illustrating the head unit 2 and the flushing unit 11 provided in the printer of this embodiment when seen from the transportation direction of the printing sheet.

As illustrated in the drawing, the printer of this embodiment does not include the vibration suppressing portion 30 provided in the printer 1 of the first embodiment, and includes a shaft support portion 19 (support portion) formed as a spring instead of the shaft portion 18 axially supporting the pulley 20.

The shaft support portion 19 functions as a vibration suppressing means of the invention for damping the vibration of the absorbing member 12.

According to the invention with such a configuration, the vibration of the absorbing member 12 is transmitted to the shaft support portion 19 via the pulley 20, and hence the shaft support portion 19 is elastically deformed. As a result, the restoring force of the shaft support portion 19 is transmitted to the absorbing member 12 via the pulley 20, so that the vibration of the absorbing member 12 can be damped.

Therefore, according to the printer of this embodiment, it is possible to damp the vibration of the absorbing member 12 with a simple and easy configuration.

While the preferred embodiments of the invention are described as above with reference to the accompanying drawings, it is needless to say that the invention is not limited to the preferred embodiments, and the preferred embodiments may be combined with each other. It is apparent that various modifications and corrections can be made by persons skilled in the art within the scope of the technical spirit according to the claims, and it should be, of course, understood that the modifications and corrections are included in the technical scope of the invention.

For example, in the above-described embodiments, a configuration has been described, in which the vibration suppressing portion 30 and the nipping member 40 come into contact with the absorbing member 12 while the vibration suppressing portion 30 and the nipping member 40 are not vibrated.

However, the invention is not limited to this configuration, but a configuration may be adopted in which the vibration suppressing portion 30 and the nipping member 40 are disposed close to the absorbing member 12, and come into contact with the absorbing member 12 when the absorbing member 12 is vibrated.

Further, in the above-described embodiments, a configuration has been described in which a single line head is provided as the printing head 21. However, the invention is not limited thereto, and a plurality of heads may be arranged in accordance with the effective printing width. At this time, the plurality of heads may not be arranged in series, but may be arranged in an overall zigzag pattern.

Likewise, when the plurality of heads is arranged in a zigzag pattern, the printing heads arranged in series in accordance with the effective printing width are spaced from each other. For this reason, the vibration suppressing portion 30 or the nipping member 40 may be installed in a gap formed between the printing heads spaced from each other.

Furthermore, a cleaning mechanism that cleans the absorbing member 12 may be installed in the printer of this embodiment. In this case, when the cleaning mechanism is disposed on the downstream side of the movement direction of the absorbing member 12 (on the downstream side of the pulley 20B), a cleaning process of cleaning the absorbing member 12 absorbing the ink can be performed. Since the absorbing member 12, which can be used again due to the cleaning process, is wound around the rotation portion 16, the flushing process can be performed again by rotating, for example, the rotation portions 15 and 16 in the reverse direction.

Further, the number of the absorbing members may be appropriately set in accordance with the nozzle rows L of the printing head 21. In the above-described embodiments, one absorbing member is provided for each of the nozzles rows L, but one absorbing member may be provided for plural nozzle rows L. In this case, a configuration is adopted in which the width of the absorbing member is set to match the corresponding plural nozzle rows L.

Furthermore, in the first embodiment, the plural absorbing members 12 are adapted to be simultaneously wound, but may be adapted to be separately wound.

In the above-described embodiments, the configuration is described in which the absorbing members 12 extend in parallel to the extension direction of the nozzle rows. However, the invention is not limited thereto, and the extension direction of the absorbing members 12 may not be perfectly parallel to the extension direction of the nozzle rows. That is, in the invention, the meaning that the absorbing members extend along the extension direction of the nozzle rows includes the case where the extension line extending in the extension direction of the nozzle rows intersects the extension line extending in the extension direction of the absorbing members in the front region as well as the case where the extension direction of the absorbing members is perfectly parallel to the extension direction of the nozzle rows.

In the above-described embodiments, a configuration is described in which the invention is applied to the line head type printer. However, the invention is not limited thereto, but may be applied to a serial type printer.

In the above-described embodiments, a configuration is described in which the absorbing members 12 always move right below the head 21. However, the invention is not limited thereto, but may adopt a configuration in which the absorbing members 12 move to a region (for example, a region on the side portions of the head 21) deviated from the positions right below the head 21 upon retracting the absorbing members 12.

In the above-described embodiments, a configuration is adopted in which a positional relationship between the absorbing members 12 and the head 21 is changed by moving the absorbing members 12. However, the invention is not limited thereto, but a configuration may be adopted in which a positional relationship between the absorbing members 12 and the head 21 is changed by moving the head 21.

In the above-described embodiments, a configuration is described in which the absorbing members 12 and 72 are located at the sheet transporting region between the printing sheet and the head 21. However, the invention is not limited thereto, but a configuration may be adopted in which the absorbing members 12 and 72 are located at a position below the sheet transporting region during the maintenance process.

In the above-described embodiments, an ink jet printer is adopted, but a fluid ejecting apparatus for ejecting a fluid other than ink or a fluid container for storing the fluid may be adopted. Various fluid ejecting apparatuses including a fluid ejecting head for ejecting a minute amount of liquid droplet may be adopted. In addition, the liquid droplet indicates the fluid ejected from the fluid ejecting apparatus, and includes a liquid having a particle shape, a tear shape, or a linear shape. Further, here, the fluid may be a material which can be ejected from the liquid ejecting apparatus.

For example, a liquid-state material may be used, including a liquid-state material such as sol or gel water having a high or low viscosity, a fluid-state material such as an inorganic solvent, an organic solvent, a liquid, a liquid-state resin, or liquid-state metal (metallic melt), and a material in which a functional material having a solid material such as pigment or metal particle is dissolved, dispersed, or mixed with a solvent in addition to a fluid. In addition, ink or liquid crystal described in the embodiments may be exemplified as a typical example of the fluid. Here, the ink indicates general water-based ink, oil-based ink, gel ink, or hot-melt ink which contains various fluid compositions.

As a detailed example of the fluid ejecting apparatus, for example, a liquid crystal display, an EL (electro-luminance) display, a plane-emission display, a fluid ejecting apparatus for ejecting a fluid containing dispersed or melted materials such as an electrode material or a color material used to manufacture a color filter, a fluid ejecting apparatus for ejecting a biological organic material used to manufacture a biochip, a fluid ejecting apparatus for ejecting a fluid as a sample used as a precise pipette, a silkscreen printing apparatus, or a micro dispenser may be used.

In addition, a fluid ejecting apparatus for ejecting lubricant from a pinpoint to a precise machine such as a watch or a camera, a fluid ejecting apparatus for ejecting a transparent resin liquid such as a UV-curing resin onto a substrate in order to form a minute hemispherical lens (optical lens) used for an optical transmission element or the like, or a fluid ejecting apparatus for ejecting an etching liquid such as an acid liquid or an alkali liquid in order to perform etching on a substrate or the like may be adopted. Further, the invention may be applied to any one of the fluid ejecting apparatuses and a fluid container thereof.

What is claimed is:

1. A fluid ejecting apparatus comprising:
a fluid ejecting head which includes a nozzle row formed of a plurality of nozzles ejecting a fluid;
a linear fluid absorbing member which extends along the nozzle row, and is movable between a position of receiving the fluid ejected from the nozzles and a position retreating from a flying path of the fluid; and
a vibration suppressing member which damps vibration of the fluid absorbing member.

2. The fluid ejecting apparatus according to claim 1, wherein the linear fluid absorbing member is larger than the diameter of the nozzle by 15 to 50 times.

3. The fluid ejecting apparatus according to claim 2, wherein the vibration suppressing member includes a contact portion coming into contact with the fluid absorbing member, and an elastic body connected to the contact portion and damping the vibration by the use of its elastic deformation.

4. The fluid ejecting apparatus according to claim 2, wherein the vibration suppressing member is a nipping member which movably nips the fluid absorbing member, and damps the vibration by the use of friction resistance generated between the fluid absorbing member and the nipping member.

5. The fluid ejecting apparatus according to claim 4, wherein the nipping member nips the fluid absorbing member in a slit between two pieces formed by dividing the nipping member.

6. The fluid ejecting apparatus according to claim 4, wherein the nipping member nips the fluid absorbing member in a slit between two plate members.

7. The fluid ejecting apparatus according to claim 2, wherein the vibration suppressing member is a support portion elastically supporting a pulley around which the fluid absorbing member is wound.
